(19) United States
(12) Patent Application Publication
(10) Pub. No.: US 2003/0072846 A1
(43) Pub. Date: Apr. 17, 2003

(54) Package for controlling dietary caloric intake

(76) Inventor: Theresa Ann King, Atlanta, GA (US)

Correspondence Address: HANDAL & MOROFSKY, 80 WASHINGTON STREET, NORWALK, CT, 06854, US

(21) Appl. No.: 09/981,334

(22) Filed: Oct. 16, 2001

(51) Int. Cl. A23L 1/00

(52) U.S. Cl. 426/87

(57) ABSTRACT

This invention relates to a decorative container for controlling dietary intake comprising: a sculptural frame, the frame defining an inner receiving surface; a product containing package, having at least a portion of the front portion being transparent. The product containing package having a generally annular sidewall configured and dimension to mating we be engaged by said inner receiving surface. Further, the product containing package's annular sidewall can defines a valley for lockingly engaging the inner receiving surface of the sculptural frame. An individual or a plurality of decorative containers being contained within a support member.

### STATEMENT REGARDING FEDERALLY SPONSORED RESEARCH OR DEVELOPMENT

(Not applicable.)

### BACKGROUND OF THE INVENTION

Over the eons, human beings have evolved in an environment of scarcity. Accordingly, human beings are usually capable, indeed desirous of eating at any time. Such natural tendencies are amplified in the presence of food, whether the same is seen, smelled or simply when the location of the same is known. Today, however, and particularly so in the United States of America, scarcity has been replaced by wide availability of large quantities of inexpensive food, much of it of superlative quality. Accordingly, the natural tendency to eat is out of place and dangerous, and instincts honed for countless millennia to work in favor of survival are now located in a environment where they can easily cause the opposite effect.

The disadvantages of overeating are even now being discovered. While, a hundred years ago, weight was considered to be healthy, and perhaps in the context of health conditions at that time even favored survival if such overweight was moderate, quite the opposite view has emerged in the last fifty years. In addition to the well known damage done by excess fat in terms of stress on the heart, limbs and other parts of the body, it has now become apparent that even at the cellular level, the longevity of cells is adversely impacted by excess caloric intake. Accordingly, strategies for “caloric deprivation” as a mechanism for increasing human life span have evolved.

Notwithstanding the acknowledged health benefits of maintaining low to normal body weight and, of course, the incentives to simply look good, the vast majority of Americans are overweight to varying extents. In an attempt to address this problem, numerous strategies have evolved. These strategies, to varying degrees do work for some segment of the population, with various strategies working better for some rather than others. Generally, diet plans work by varying the amount and type of foods which the person who is trying to lose or maintain weight eats. For example, some diets attempt to remove starch from the diet and increase the amount of protein consumed by the individual. Other diets seeks to remove high calorie substances having deleterious health effects, such as hard animal fats, for example, butter, cheese and fatty meats.

Still another approach involves the psychology of eating. For example, some diets stress the intake of salads and other high volume foods which satisfy the need for the appearance of the consumption of food by the person on the diet. Such approaches are relatively successful for many people.

As can be seen from the above, these traditional approaches work by directly attacking the problem, namely, reducing the intake of food and or psychologically trying to satisfy the individual's desire to consume food.

Nevertheless, both of these approaches merely address hunger and satisfaction but do not attack directly the natural tendency of an individual, upon seeing some food, to desire to eat that food, if it suits the taste.

Recently, substantial success has been achieved by an almost cult-like approach to dieting. In particular, at least one religious group has begun to preach to its members about the moral inappropriateness of overeating. This harkens back to traditional religious teachings of the middle ages regarding the cardinal sin of overeating. In any case, this almost cult-like approach has been successful in helping many individuals to reduce weight where other approaches have failed. Not surprisingly, however, many members of the public have taken issue with the approach employed here.

### SUMMARY OF THE INVENTION

In accordance with the invention, positive psychological incentives are provided to prevent consumption of food, particularly when an individual is not hungry. The same is achieved through the use of a packaging system which, at the same time, is attractive and makes it unnecessary to have closet space within which to store the food product. In addition, the same is achieved while providing numerous compartmentalized portions of various food varieties, thus providing the opportunity to maintain freshness and provide variety.

In accordance with one embodiment of the invention the same is achieved through providing a plurality of individual packages each of which has a particular pleasing shape, with all of the shapes working together to provide an overall decorative appearance. This decorative appearance is enhanced by the contents of the packages which are visible from outside the packages thus contributing to the overall sculptural effect.

In accordance with the preferred embodiment, this sculptural effect is unified, for example, a flower pot with flowers, a swimming pool with a number of swimmers diving into it, or the like. Each of the individualized compartments has a decorative shape and is transparent for containing and displaying a quantity of an edible product, such as peanuts, cookies, raisins or the like. The overall arrangement, for example, of flowers in a pot, is set up to be attractive as a whole. The contents of the transparent packages which form the actual blossom portions of the flower are mounted on stems which, in turn, are mounted in a base such as a flower pot. The base may be filled with Styrofoam or other similar materials suitable for receiving support stems and supporting stems with “blossom” packages at the top end of the stem.

In accordance with the invention, the flower pot with the various blossoms in it filled with foods, such as peanuts, raisins or the like or filled with a single item of food, such as a cookie. The overall decorative appearance is more attractive then the empty packages. Accordingly, in accordance with the invention, psychological incentives exist, in least some individuals, to discourage the consumption of the food in the individual transparent packages. Such effects may be observed, for example, in the case of birthday cakes, where particularly beautiful parts of the decoration of a birthday cake maybe left till the last consumption, in order to preserve the aesthetic beauty of the birthday cake. The same psychological forces will deter the consumption of food in these decorative packages constructed in accordance with the invention.

### BRIEF DESCRIPTION OF THE DRAWINGS

One or more embodiments of the invention and of making and using the invention, as well as the best mode contemplated of carrying out the invention, are described in detail below, by way of example, with reference to the accompanying drawings, in which:

FIG. 1 is a front view of an embodiment of the present invention;

FIG. 2 is a front view of an embodiment of the container of the present invention illustrated in FIG. 1;

FIG. 3 is a side view of the embodiment of the container illustrated in FIG. 2;

FIG. 4 is a side view of an alternative embodiment of the container illustrated in FIG. 2, further illustrating a receiving member for the support member of the embodiment of the present invention illustrated in FIG. 1;

FIG. 5 is a front view of the decorative fascia of the embodiment of the present invention illustrated in FIG. 1;

FIG. 6 is a front view of an alternative embodiment of the present invention further illustrating multiple containers per package, where each container is different from the others in size and shape;

FIG. 7 is a front view of an embodiment of the present invention wherein the decorative fascia and container are configured to look like a pig's head;

FIG. 8 is a front view of an embodiment of the present invention wherein the decorative fascia and container are configured to look like a baseball hat with a sample message;

FIG. 9 is a rear view of an embodiment of the present invention, further illustrating a label providing a message, and securing the support to the container of the present invention;

FIG. 10 is a cross-sectional view of the base portion illustrated in FIG. 1 further illustrating a support material to hold the packaging system in place;

FIG. 11 is a top view of an alternative embodiment of the support material;

FIG. 12 is a cross-sectional view of the support material of FIG. 11 in a base;

FIG. 13 is a front view of an alternative embodiment of the present invention, where the support member is configured and dimensioned to accept the container;

FIG. 14 is a front view of the support of the embodiment illustrated in FIG. 13;

FIG. 15 is a front view of the decorative fascia of the embodiment illustrated in FIG. 13;

FIG. 16 is a front view of an alternative embodiment of a container of the present invention;

FIG. 17 is a side view of a container of the present invention illustrated in FIG. 16;

FIG. 18 is a front view of an alternative embodiment of the present invention wherein the aesthetic aspect of the invention is from the arrangement of the containers;

FIG. 19 is a front view of a single container in an open position of the embodiment of the present invention illustrated in FIG. 18;

FIG. 20 is a front view of a single container in a closed position of the embodiment of the present invention illustrated in FIG. 18;

FIG. 21 is a side view of the embodiment of the present invention illustrated in FIG. 18;

FIG. 22 is a front view of an alternative embodiment of the present invention wherein the containers are arranged for three dimensional aesthetics;

FIG. 23 is a top view of the embodiment of the present invention illustrated in FIG. 22 with one of the containers in the positions;

FIG. 24 shows an inventive decorative object incorporating a product, such as a cookie;

FIG. 25 is a view along the line 25—25 of FIG. 24 showing the construction of the inventive decorative object illustrated in FIG. 24;

FIG. 26 shows a clamshell container useful in accordance with the present invention;

FIG. 26A shows a clamshell container useful in accordance with the present invention very similar to the embodiment illustrated in FIG. 26 without holes in the rear cover;

FIG. 27 illustrates the details of the locking mechanism for the clamshell illustrated in FIG. 26 with a view similar to that a FIG. 25 but enlarged and exaggerated to illustrate function;

FIG. 28 is a detail plan views showing an inventive mechanism for locking product carrying member into a decorative frame;

FIG. 29 is a view along lines 29-29 of FIG. 28;

FIG. 30 is a plan view of the decorative arrangement of decorative objects such as that illustrated in FIGS. 24-29;

FIG. 31 is a plan view along lines 31—31 of FIG. 30;

FIG. 32 is a view of an inspirational sign useful in the arrangement illustrated in FIG. 30; and

FIG. 33 illustrates an alternative locking arrangement for locking a product carrier into a decorative frame.

### DETAILED DESCRIPTION OF THE INVENTION

In accordance with the invention, positive psychological incentives are provided to prevent consumption of food, particularly when an individual is not hungry. The same is achieved through the use of a packaging system which, at the same time, is attractive and makes it unnecessary to have closet space within which to store the food product.

More specifically, FIG. 1 illustrates a packaging system for controlling dietary caloric intake 10, package 10 is comprised of a container 12, a decorative fascia 14 and a support 16. Support 16 is positioned in base 18, which contains a material 20 that holds support 16 in place within base 18.

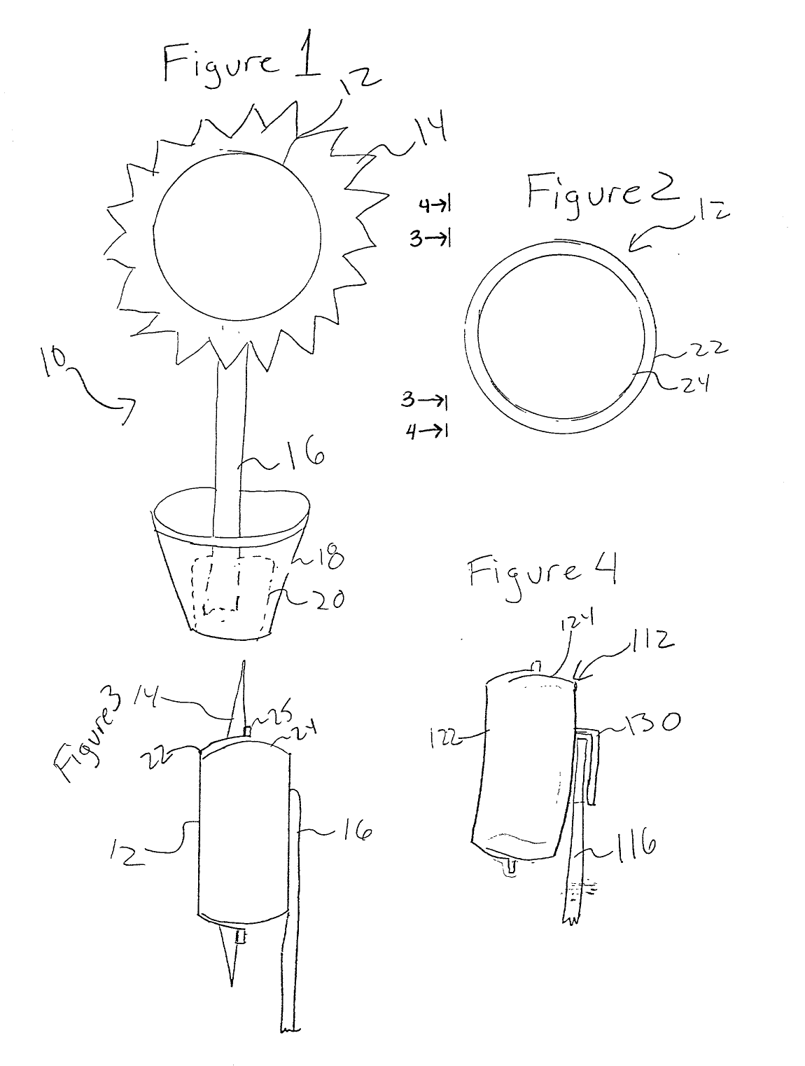

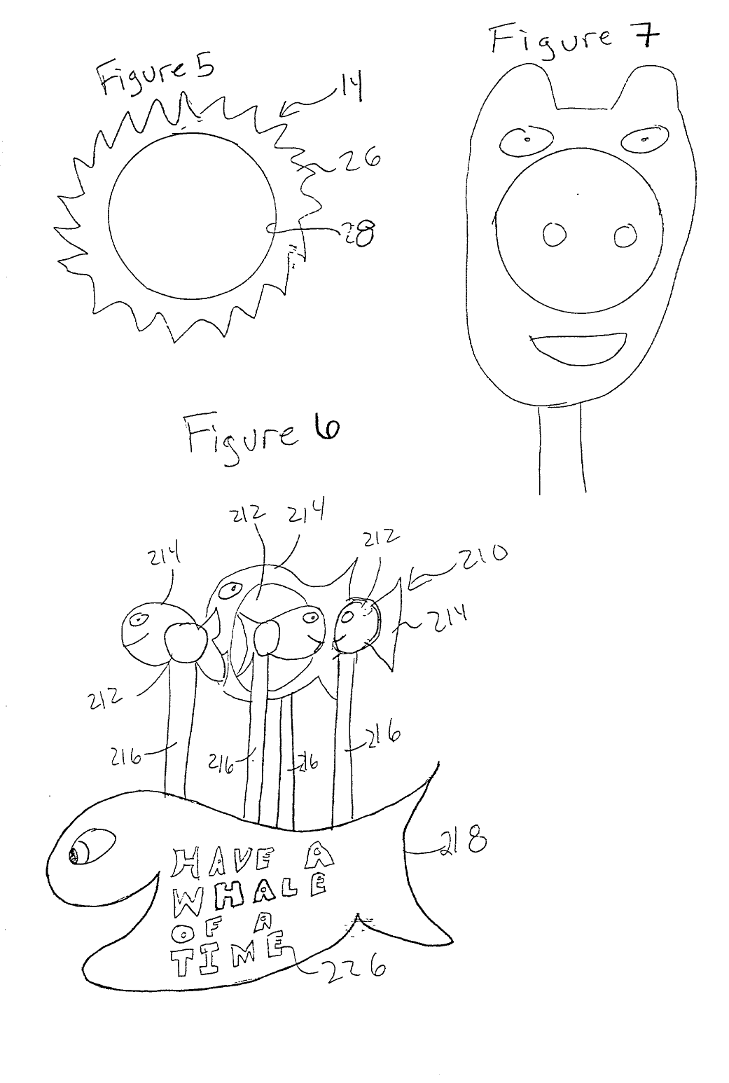

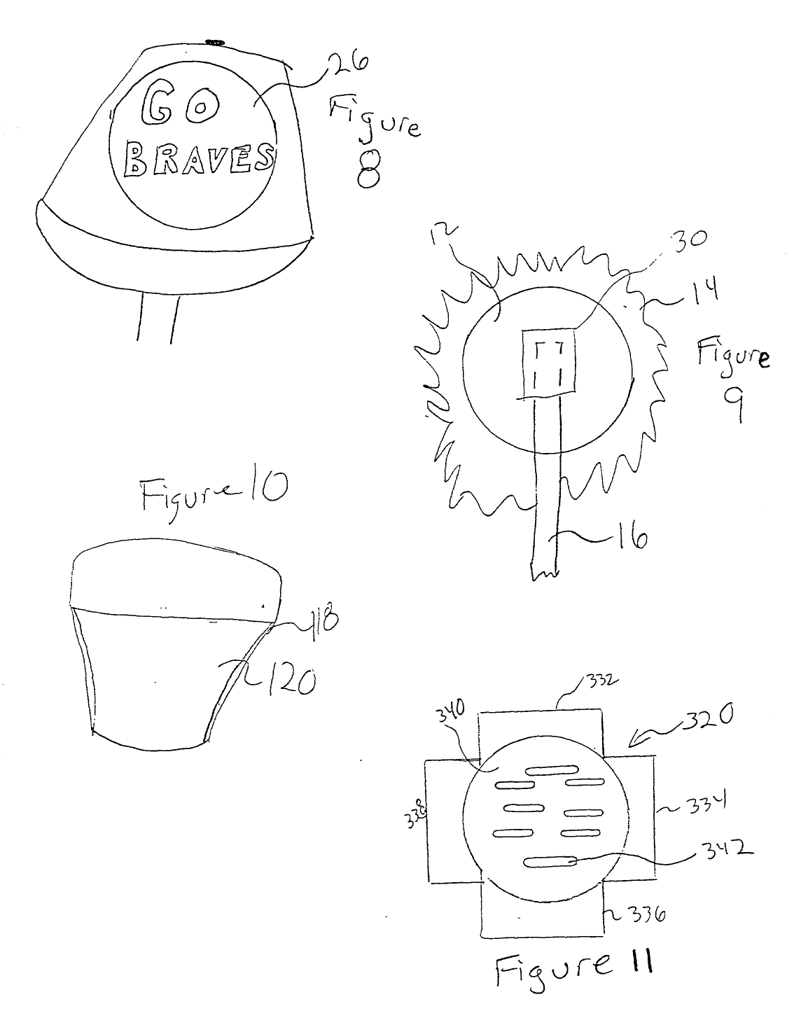

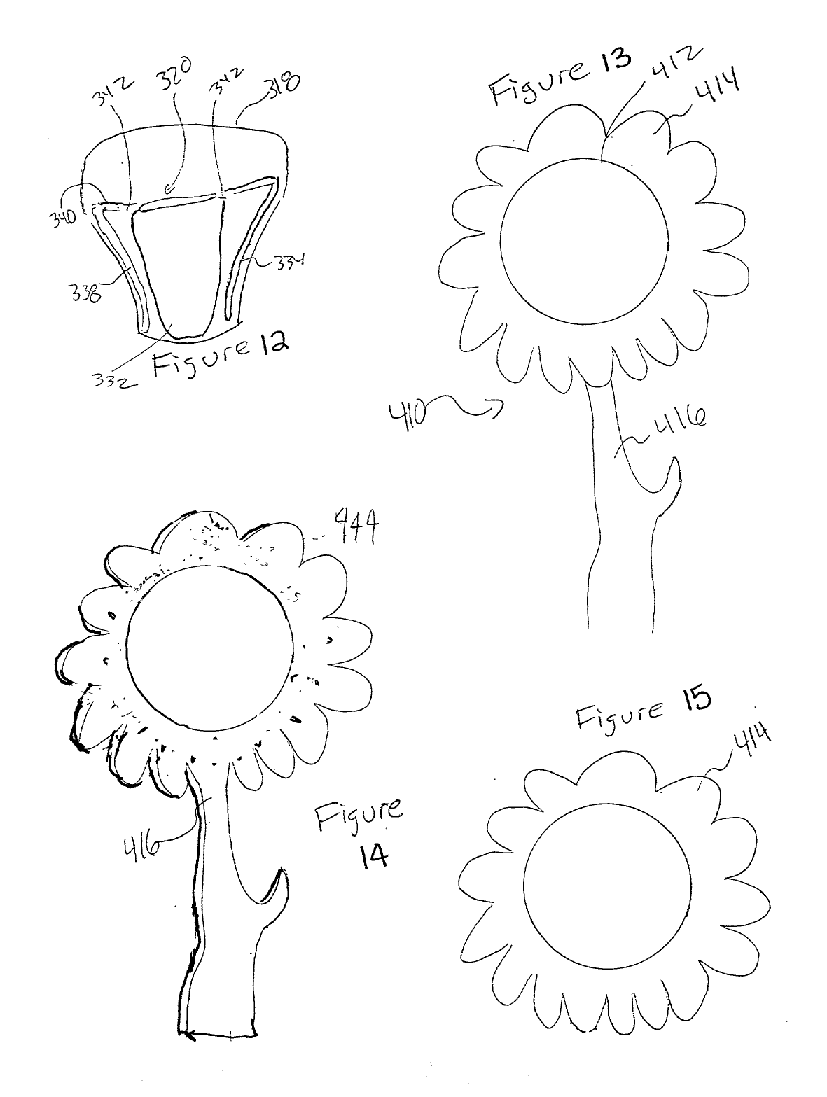

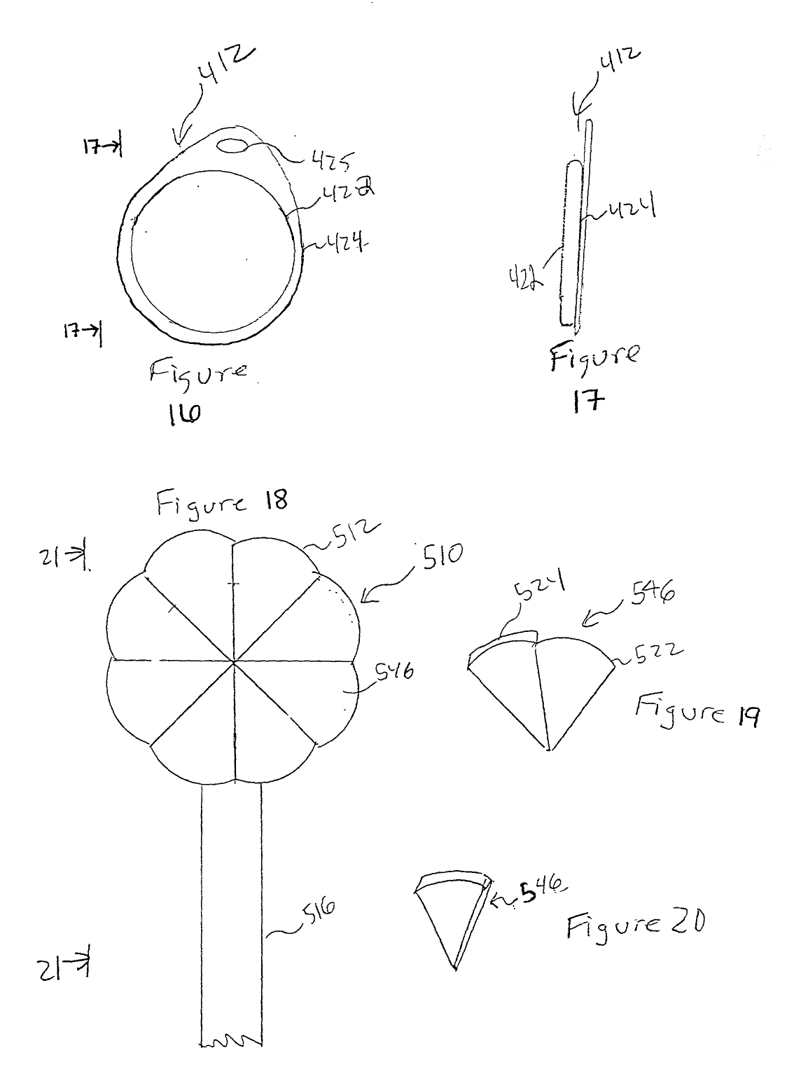

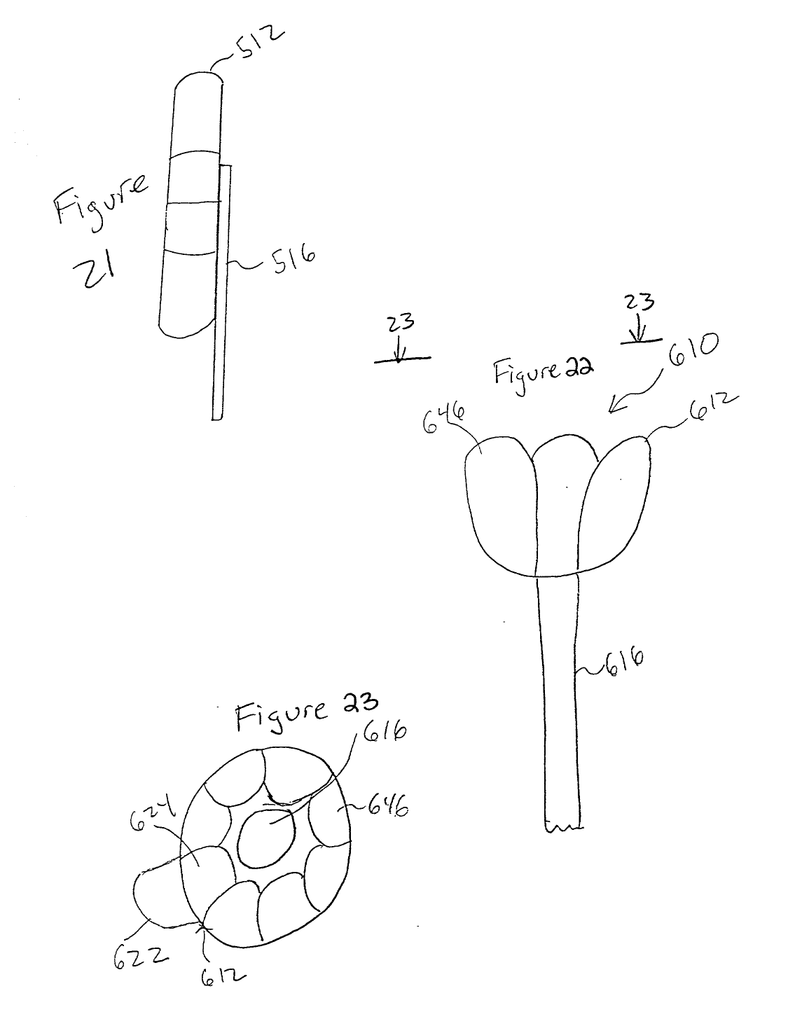

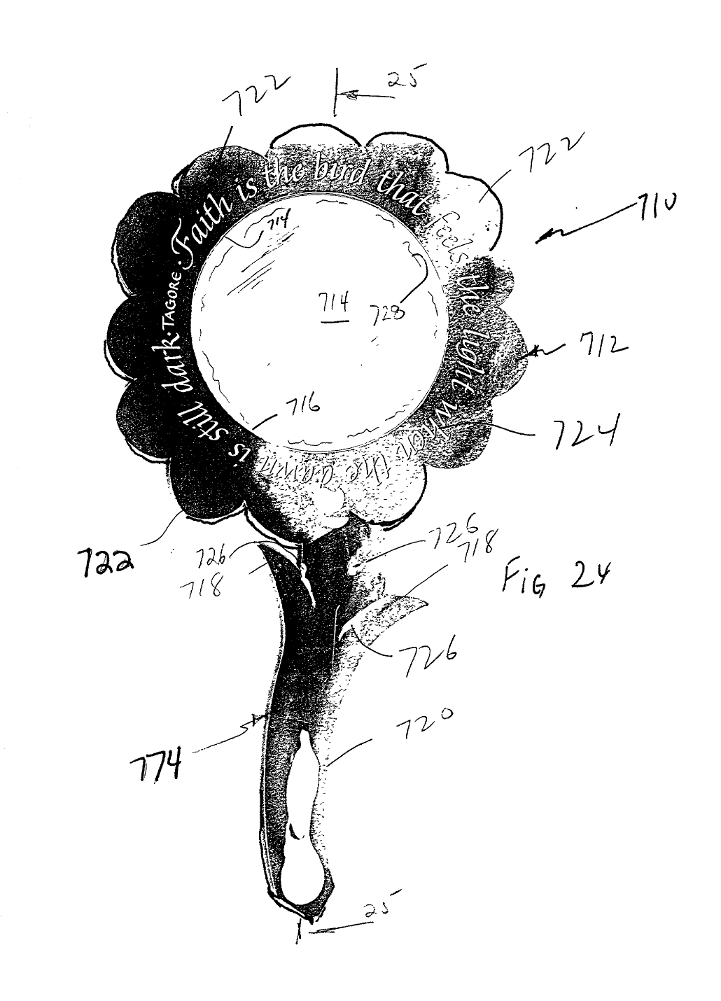

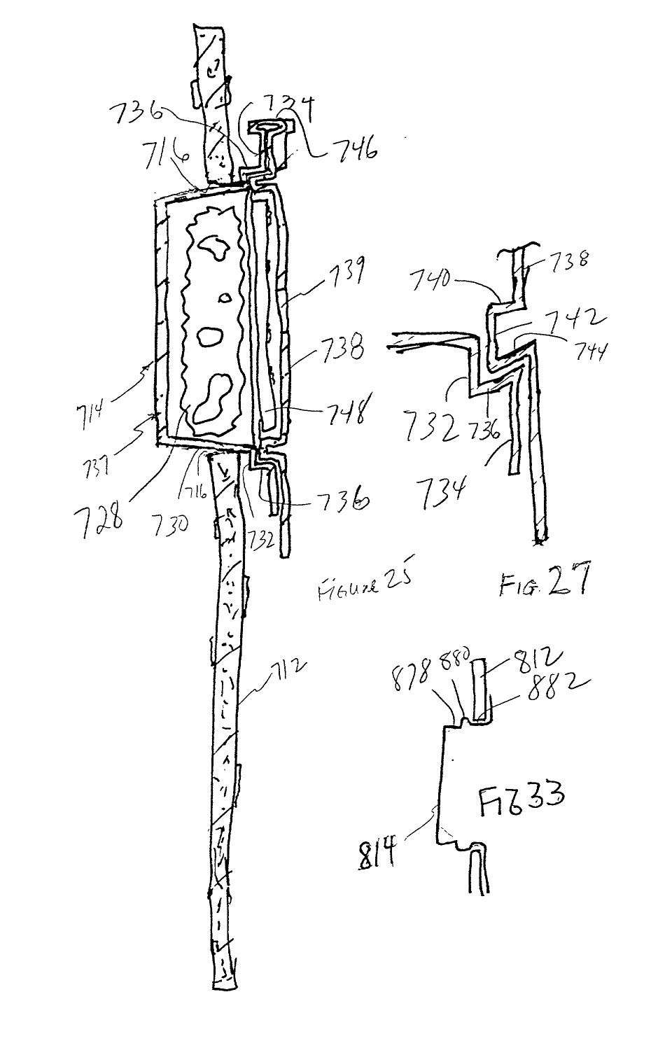

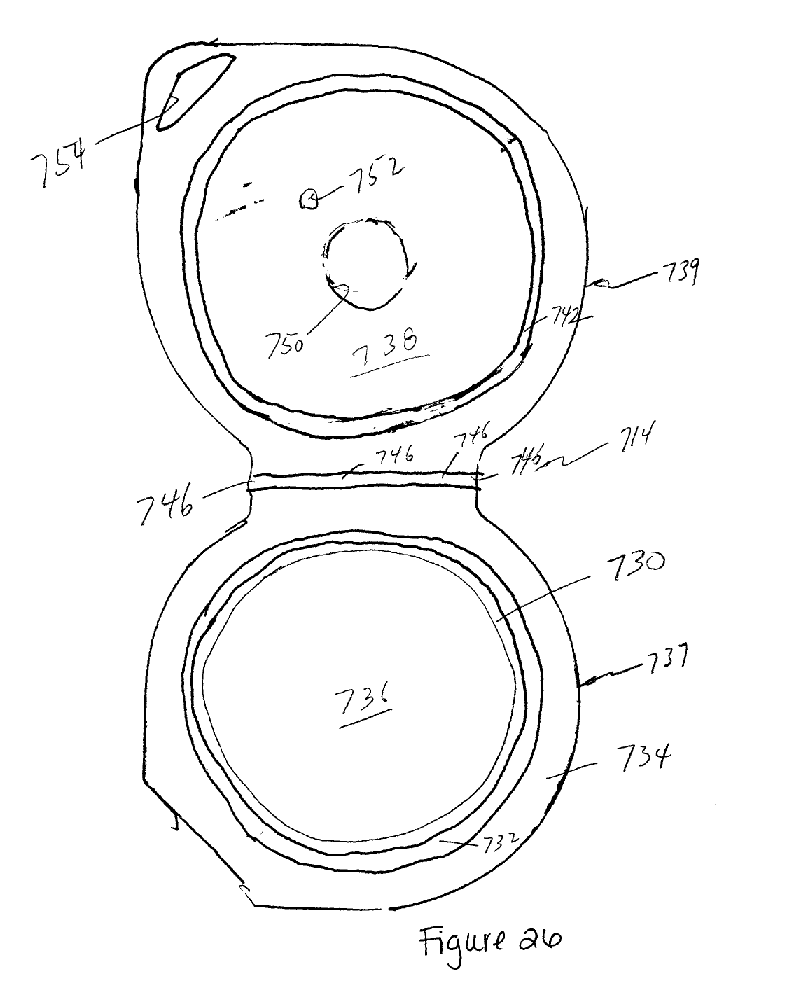

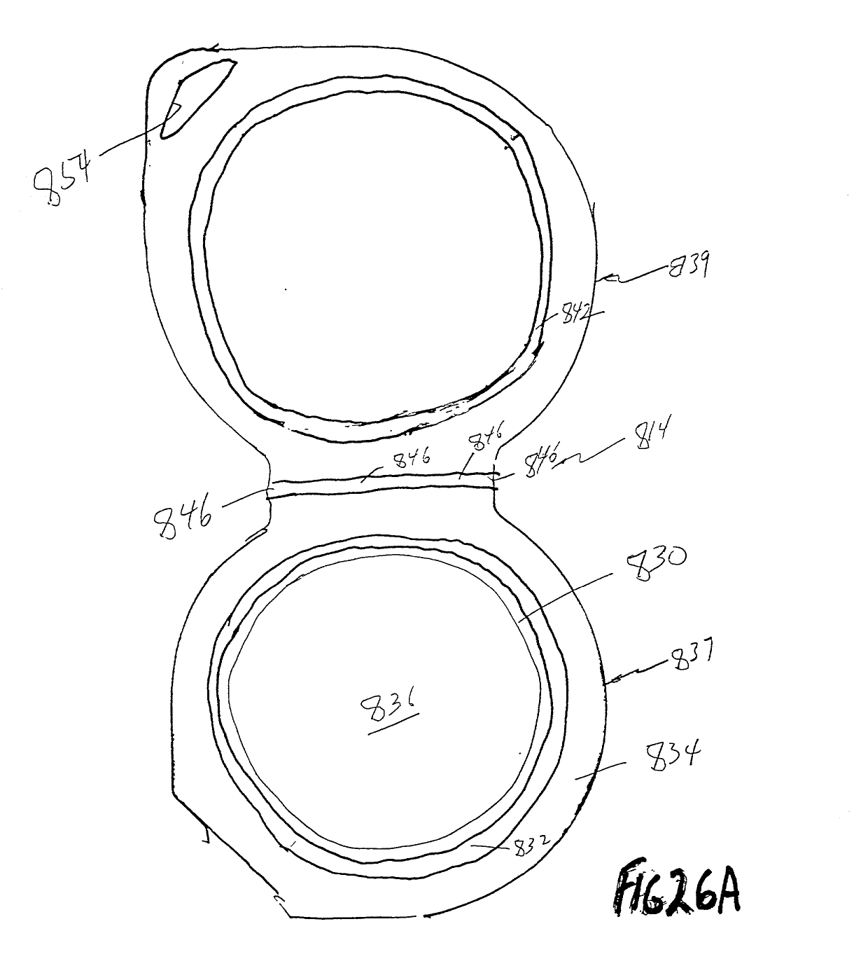

FIG. 2 illustrates a container 12 in accordance with the preferred embodiment. Container 12 is comprised of a lid 22 and a base portion 24. Base portion 24 is configured and dimensioned such that it can receive items that a gift giver would like to give to the recipient, including but not limited to: food items such as candy, coffee, chocolates, hot cocoa mix, sunflower seeds, nuts, cereal, a dry mix for cookies, prepared cookies, pasta, bath items such as bath salts, soaps, bath beads, and potpourri. Lid 22 is secured to base portion 24 by any means common in the container arts, such as friction, adhesive, tape or by a label 30.

Container 12 is affixed to support 16 by any common means, such as with adhesive, adhesive tape, or fastener, as is illustrated in FIG. 3. Further, lid 22 and/or base portion 24 of container 12 can contain a lip to which fascia 14 can be attached. Alternatively, container 112 can contain a support receiving section 130 which can securedly receive support 116.

Container 12 can come in a variety of sizes and shapes as will be described in more detail.

Turning now to FIG. 5, decorative fascia 14 is illustrated. Decorative fascia 14 is comprised of an outer area 26 and an inner ring 28. Outer area 26 can be shaped to represent a wide varied of items, such as a sun, a fish (FIG. 6), a pig head (FIG. 7), or a baseball cap (FIG. 8) with a message 26 on container 12 supporting a team, for example. Inner ring 28 is configured and dimensioned to surround container 12 such a manner as to allow securing between container 12 and fascia 14.

FIG. 9 illustrates the placement of the label, affixing support 16 to container 12. The label could contain information of the product contained with the package, a message about the manufacturer of the product, a message from the purchaser of the product for the recipient, or a message from the store selling the product.

Turning now to material 20, FIG. 1 illustrates a block of material 20 placed in base 18. Alternatively, base 18 can be filled with material 120 which is designed to conform to the inner surfaces of base 118, as is illustrated in FIG. 10. Material 20 can be of any type commonly used, such as styrofoam, sand, packing “peanuts”, or florist's foam. Material 20 must be of a density sufficient to keep package 10 from moving within base 18.

Alternatively, as illustrated in FIGS. 11 and 12, material 320 can be made of a rigid board-like material, such as cardboard with flaps 332, 334, 336 and 338 that can folded to conform to the inside of base 318. The support engaging surface 340 having voids 342 cut out to accept supports 316 and hold them in place.

Additionally, material 20 can be composed of a combination of rigid board like material as illustrated in FIGS. 11 and 12 and any type commonly used, such as styrofoam, sand, packing “peanuts”, or florist's foam.

In another embodiment, base 218 can contain multiple packages 210 as is illustrated in FIG. 6. Base 218 containing packages 210 of many shapes and sizes. Further, FIG. 6 illustrates base 218 in an optional shape, in this embodiment as a fish. Additionally, base 218 contains an optional message 226.

In a preferred alternative embodiment illustrated in FIGS. 13-15, package 410 is comprised of a container 412 made of clear plastic, a decorative fascia 414, and a support 416. Support 416 is a one piece unit having an upper portion 444 which is cut out in the same shape as fascia 414 and designed to receive fascia 414 by any common means, such as adhesive, stitching, or fasteners. Fascia 414 being made up of pieces, a front and a back piece designed to cover the front and back surfaces of upper portion 444.

FIGS. 16 and 17 illustrate an alternative container design 412. Container 412 is comprised of a lid 422 and a base portion 424. Base portion 424 is configured to receive items that a gift giver would like to give. Additionally, base portion 424 can have a void 425 that can be used to store the containers off of a horizontal surface, such as a shelf or counter-top. Lid 422 is secured to base portion 424 by any means common in the container arts.

In the embodiment illustrated in FIG. 19-21, package 510 is comprised of a container 512 and a support 516. Container 512 has multiple chambers 546. Each chamber having a base portion 524 and a lid 522. Lid 522 being secured to base portion 524 by any means common in the container arts. Each chamber 546 can be filled with a different gift. Additionally, chamber 546 can be a varied in color, shape and size such that container 512 can have varied designs, such as a fish, flower, or automobile. Support 516 is attached to container by any means common in the art.

In a further embodiment, illustrated in FIGS. 22 and 23, package 610 is comprised of a container 612 and a support 616. Container 612 being comprised of multiple chambers 646. Each chamber has a base portion 624 and a lid 622. Lid 622 being secured to base portion 624 by any means common in the container arts. Support 616 is configured and dimensioned such that container 612 extends longitudinally from a portion of support 616.

In accordance with one embodiment of the invention the same is achieved through providing a plurality of individual packages each of which has a particular pleasing shape, with all of the shapes working together to provide an overall decorative appearance. This decorative appearance is enhanced by the contents of the packages which are visible from outside the packages thus contributing to the overall sculptural effect.

In accordance with the preferred embodiment, the overall decorative appearance is more attractive then the empty packages. Accordingly, psychological incentives exist, in least some individuals, to discourage the consumption of the food in the individual transparent packages. Such effects may be observed, for example, in the case of birthday cakes, where particularly beautiful parts of the decoration of a birthday cake maybe left till the last consumption, in order to preserve the aesthetic beauty of the birthday cake. The same psychological forces will deter the consumption of food in these decorative packages constructed in accordance with the invention.

By adding non-food items in with the food items, the incentive exists to leave the arrangement as a whole and not binge, thus leaving on the non-food items, leaving a sparse appearance.

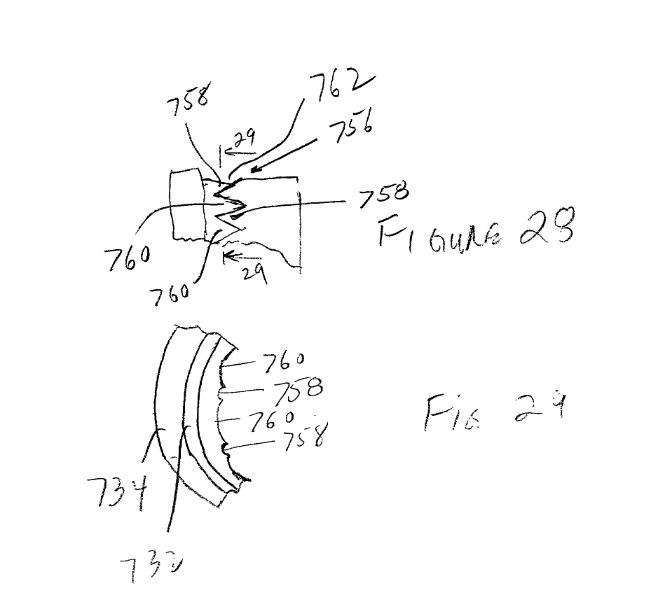

A particularly preferred embodiment of the invention is illustrated in FIG. 24. In particular, in accordance with this embodiment of the invention, a simulated decorative object 710 comprises a support frame 712, and a transparent product carrier 714. Support frame 712 defines an inner circumferential hole 716 which supports transparent product carrier 714. Support frame 712 defines various decorative elements, including leaves 718, a stem 720, and flower petals 722. An inspirational message 724 is imprinted on the surface of support frame 712. In the illustrated example the inspirational message does “Faith Is the Bird That Feels the Light When the Dawn Is Still Dark-Tagore”. Of course, anyone of numerous other inspirational messages may be used in accordance with the invention. In addition, various features 726 defining parts of the simulated decorative object are imprinted on the surface of support frame 712. Such imprinting may be done by any suitable technique, such as offset printing, silkscreen printing, hand painting or like.

In accordance with the invention, support frame 712 may be made of any suitable material, such as corrugated cardboard, cardboard without corrugations, plastic, or any other suitable and preferably inexpensive material that has the rigidity and strength to support product carrier 714 with a product in its such as bath beads, a chocolate chip cookie, nuts, or like. In the illustrated example, a cookie 728 can be seen through the pace of transparent product carrier 714. The same may be manufactured by anyone of numerous techniques well-known in the art, such as die cutting, hand cutting with a blade, or any other suitable procedure.

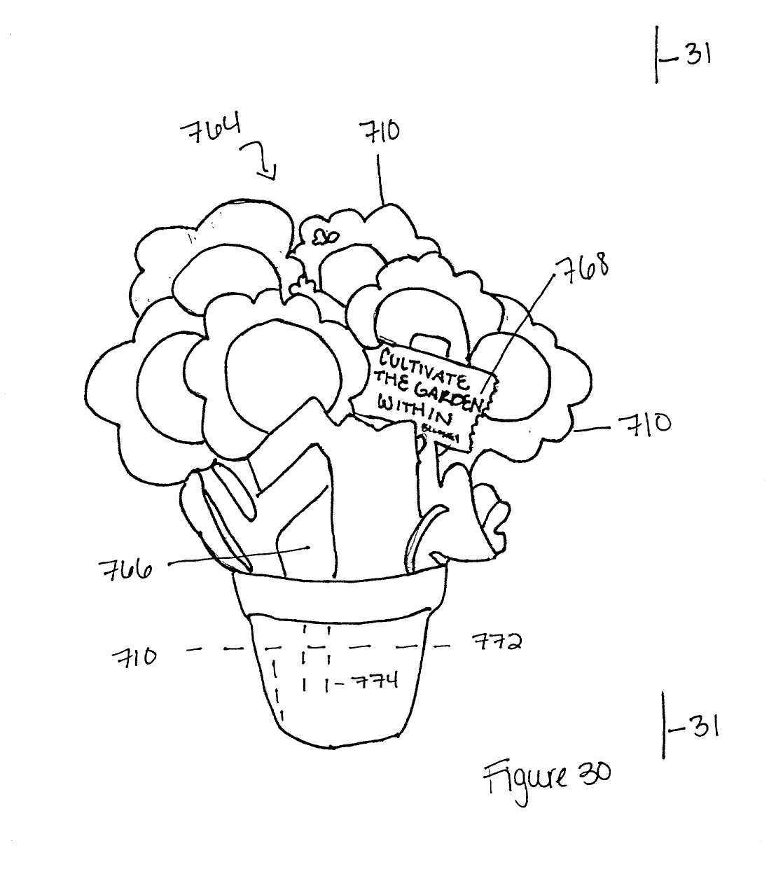

Referring to FIGS. 25 and 26, the construction of transparent product carrier 714 may be better understood. In particular, transparent product carrier 714 includes a sloped sidewall 730 adapted to be received by the inner circumferential hole 716. A shoulder 732 lends rigidity to the structure and this rigidity is reinforced by rim 734. The face 736 of transparent carrier 714, together with a conical sidewall 730, shoulder 732, annular cylindrical section 736, and rim 73 4 forms the front portion 737 of transparent product carrier 714.

As can be seen most clearly with reference to FIGS. 26 and 27, rear portion 739 of transparent product carrier 714 is formed by a rear face 738, cylindrical annular portion 740, ring-shaped support surface 742, and facing cylindrical annular portion 744.

As can be seen most clearly with reference to FIG. 26, transparent product carrier 714 is formed from clear, transparent and preferably colorless plastic in a slight configuration which includes a substantially straight elongated creasing portion 746, along which transparent product carrier 714 is folded to form the product carrier into the configuration illustrated in FIG. 25. The particular, when it is desired to form simulated decorative object 710, a product, such as cookie 728 is inserted into front portion 737, and a backer cardboard 748 or paper label is inserted into rear portion 739. Front portion 737 and rear portion 739 are then popped into mating and locking engagement with each other.

The mating and locking engagement referred to above may be understood with respect to FIG. 27. In particular, annular cylindrical section 736 is slightly conical and configuration sloping radially inwardly toward the rear of the carrier, and mating annular cylindrical section 744 is also slightly conical in configuration and slopes radially inwardly toward the rear of the carrier, but has a slightly smaller radius, best resulting in structures which locking in position. We can spend plastic of which transparent product carrier 714 is made, is flexible and thus allows the surfaces to bend and flex into mating locking arrangement.

The rear portion 739 includes a variety of holes, including, a large hole 750 and a small hole which performs the function of allowing air exchange between the environment and the inside of carrier 714. For example allowing fragrances of potpourri or bath salts to escape the product carrier 714. Additionally, the holes 750 can be finger gripping hole 750 which allows the user to grasp transparent product carrier 714 and open it.

A carrier 814 without holes (FIG. 26A)can also be utilized when air exchange is not desirable, such as when cookies are contained within carrier 814.

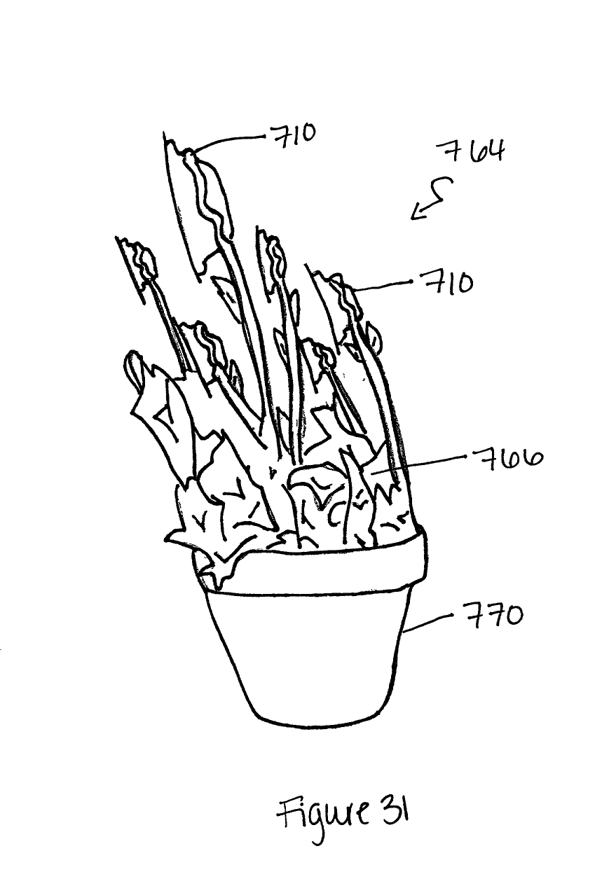

In accordance with the embodiment illustrated in FIGS. 24-27, sloped conical sidewall 730 includes surface features 756 adapted to retain transparent product carrier 714 within support frame 712. In particular, with reference to FIGS. 28 and 29, such surface features may take the form of curved upper triangular indentations 758 which fit into curved lower triangular indentations 760. Together, curved upper triangular indentations 758 and curved lower triangular indentations 760 form an annular valley 762 which lockingly receives the inner circumferential surface of inner circumferential hole 716 of support frame 712.

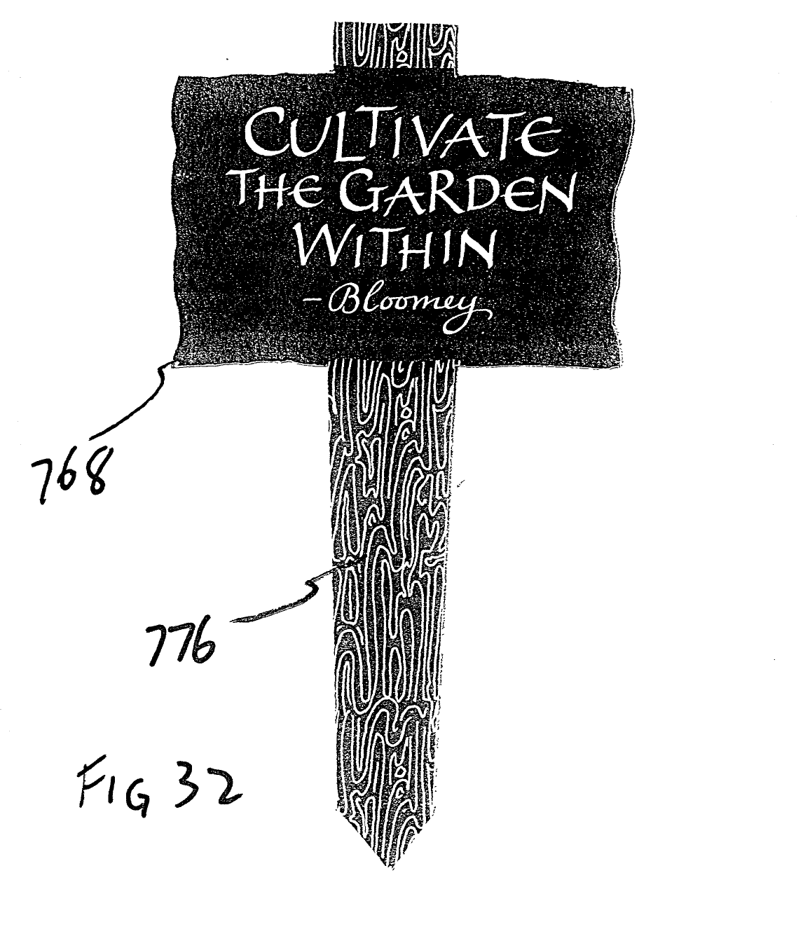

In accordance with the preferred embodiment, it is contemplated that a plurality of simulated decorative objects 710 will be arranged in a bouquet or other arrangement 764, as illustrated in FIGS. 30 and 31. The inventive arrangement 764 may also include other elements, such as tissue paper 766, an inspirational sign 768 (FIG. 32) and a container such as one shaped as a power pot 770. Inside flowerpot 770 is a cardboard or home plastic or other support 772 which receives the stem portions 774 of simulated decorative objects 710, and, if included in the post portion 776 of inspirational sign 768. The decorative bouquet being covered in a cellophane-like material for transport and display.

FIG. 33 illustrates an alternate mechanism for locking a product carrier into a decorative frame other than that illustrated in FIGS. 28 and 29 did indicate it, any arrangement which provides for a valley said his belly 762 large enough to receive the decorative frame, such as support frame 712 will function to retain a package such as product carrier 714. In particular, FIG. 33 illustrates a product carrier 814 with a non-conical sidewall 878 which includes an annular bump which defines an annular valley 882 for lockingly receiving a decorative support frame 812.

In the description, reference is made to the accompanying drawings, which form a part hereof, and which illustrate examples of the invention. Such examples, however, are not exhaustive of the various embodiments of the invention, and therefore, reference is made to the claims which follow the description for determining the scope of the invention. While illustrative embodiments of the invention has been described, it is, of course, understood that various modifications of the invention will be obvious to those of ordinary skill in the art. Such modifications are within the spirit and scope of the invention which is limited and defined by the appended claims.

We claim:

1. A package for controlling dietary intake comprising:
(a) at least one support member;
(b) at least one container functionally connected to and supported by said at least one support member;
(c) a base member configured and dimensioned to accept at least one said support member such that said support member and said container are held in a substantially vertical position.

2. A package as claimed in claim 1 further comprising a decorative member attached to said support member or said container, or said support member and said container.

3. A package as claimed in claim 2 wherein said decorative member has the shape of a sun, flower, animal, hat, or fictional or real person, or a message, or a shape and a message.

4. A package as claimed in claim 1 wherein said base member contains 2 or more support members supporting at least 2 containers.

5. A package as claimed in claim 4 wherein said 2 or more support members and said at least 2 containers are of varied shapes and sizes.

6. A package as claimed in claim 1 wherein said package looks like a bouquet of flowers in a flower pot.

7. A package as claimed in claim 1 wherein said base further comprises a display material disposed inside a void defined by the walls and floor of said base, said display material being configured and dimensioned to hold said at least one support member and container in a substantially vertical position.

8. A package as claimed in claim 7 wherein said display material comprises a dense material.

9. A package as claimed in claim 7 wherein said display material comprises a rigid board-like material comprising flaps, and a display surface having at least one void, said flaps being configured and dimensioned to fit within said void defined by the walls and floor of said base, and position said display surface separated from said floor of said base, said voids in said display surface being configured and dimensioned to accept and support at least a portion of said support member.

10. A package as claimed in claim1 wherein said support member is connected to said container by an adhesive, fastener or label.

11. A package as claimed in claim 10 wherein said label contains information on a product contained within said container, a message from the maker of said package, a message from a sender of said package to a recipient of said package, or a design or picture.

12. A package as claimed in claim1 wherein said support member securely fits into a chamber, disposed on said container, said chamber being configured and dimensioned to accept at least a portion of said support member.

13. A package as claimed in claim 1 wherein said container comprises on at least a portion of its exposed surface a visible design or message or design and message.

14. A package as claimed in claim 1 wherein said base comprises a message or design on at least a portion of an exposed surface of said base.

15. A package as claimed in claim 1 wherein said container is comprised of more the one chamber, said more then one chamber being autonomous of each other.

16. A package as claimed in claim 15 wherein said container formed by said more then one chamber has a shape of a sun, flower, animal, hat, or fictional or real person, or a message, or a shape and a message.

17. A package as claimed in claim 1 wherein said container is comprised of more the one chamber, said more then one chamber have a communication with another chamber wherein contents of one chamber can move to another chamber.

18. A package as claimed in claim 1 wherein said container contains food items.

19. A package as claimed in claim 4 wherein each of the said at least 2 containers contain a different food item.

20. A package as claimed in claim 4 wherein each of the said at least 2 containers contain at least one food item and optionally a non-food item.

21. A method for using the package for controlling dietary intake of claim 1 comprising:
(a) receiving a package as a gift from someone else or from yourself;
(b) viewing the overall aesthetics of said package;
(c) curbing the desire to eat the contents of said package by not wanting to disturb the aesthetics of the package.

22. A method as claimed in claim 21 further comprising the step of viewing the contents of said container through the transparent container.

23. A method as claimed in claim 21 further comprising the step of hiding the contents of said container in an opaque container.

24. A decorative container comprising:
(a) a sculptural frame, said frame defining an inner receiving surface; and
(b) a product containing package, comprising:
(i) a front portion having first mating and locking structure, at least a portion of said front portion being transparent;
(ii) a rear portion having second mating and locking structure, said second mating and locking structure mating with said first mating and locking structure, said front portion and said rear portion together defining a chamber for receiving a product, said product containing package having a generally annular sidewall conFigured and dimension to mating we be engaged by said inner receiving surface.

25. A decorative container as in claim 24, wherein said the sculptural frame includes an upper portion defining said inner receiving surface and an elongated support member.

26. A decorative container as in claim 24, wherein said product containing package generally annular sidewall defines a valley for lockingly engaging said inner receiving surface.

27. A decorative container as in claim 24, wherein said product containing package generally annular sidewall defines a conical shaped for contacting said inner receiving surface.

28. A decorative container as in claim 24, wherein said front portion and said rear portion are connected to each other at a hinge to form a clamshell configuration.

29. A decorative container as in claim 24, wherein said sculptural frame comprises cardboard.

30. A decorative container as in claim 24, wherein said sculptural frame comprises a pair of facing surfaces, with printing on at least one of said surfaces, said printing comprising an inspirational message.

31. A decorative container as in claim 24, comprising a plurality of decorative containers as defined in claim 24, said plurality of decorative containers being contained within a support member.

32. A decorative container as in claim 31, wherein said support member is a pot with a support structure contained within said pot, wherein each of said the sculptural frame includes an upper portion defining said inner receiving surface and an elongated support member, said support structure receiving said elongated support members.

33. A decorative container as in claim 32, further comprising a clear plastic film, such as cellophane disposed around said pot, and said sculptural frames to provide support for said sculptural frames.

34.A decorative container as in claim 24, wherein said product containing package generally annular sidewall defines a valley for lockingly engaging said inner receiving surface, and wherein said product containing package generally annular sidewall defines a conical shaped for contacting said inner receiving surface.

35. A decorative container as in claim 34, comprising a plurality of decorative containers as defined in claim 34, said plurality of decorative containers being contained within a support member.

36. A decorative container as in claim 35, wherein said support member is a pot with a support structure contained within said pot, wherein each of said the sculptural frame includes an upper portion defining said inner receiving surface and an elongated support member, said support structure receiving said elongated support members.

37. A decorative container as in claim 36, further comprising a clear plastic film, such as cellophane disposed around said pot and said sculptural frames to provide support for said sculptural frames.
